(19) United States
(12) Patent Application Publication
(10) Pub. No.: US 2009/0113958 A1
(43) Pub. Date: May 7, 2009

(54) AUTOMOBILE STEERING WHEEL LOCK

(76) Inventor: Pin-Ying YU, Tainan City (TW)

Correspondence Address: Pin-Ying YU, P. O. BOX 90, Tainan City, 70499, TW

(21) Appl. No.: 11/934,070

(22) Filed: Nov. 1, 2007

(51) Int. Cl. B60R 25/02

(52) U.S. Cl. 70/209

(57) ABSTRACT

An automobile steering wheel lock includes a foundation base provided with an insert slot at its front end and an accommodating chamber therein with a push-in lock having an engage pin and a spring. The push-in lock is pressed to insert the engage pin in the insert hole of the foundation base. The foundation base has its lower side fixed with a clasping member having its upper end disposed with a positioning insert rod and its lower end formed with a retaining member. The positioning insert rod inserted in the insert slot has at least one pin hole for the engage pin to be inserted therethrough, having one side provided with a slide recess. A fixing pin is inserted through the accommodating chamber and fixed in the slide recess to position the positioning insert rod in the insert slot for preventing the clasping member from slipping off the foundation base.

### BACKGROUND OF THE INVENTION

1. Field of the Invention

This invention relates to an automobile steering wheel lock, particularly to one to be locked on an automobile steering wheel, able to avoid a resisting rod slipping off a foundation base for preventing the automobile from being burgled.

2. Description of the Prior Art

A conventional automobile steering wheel lock 1, as shown in FIG. 1, includes a main body 10 having one end secured with a resisting rod 11 having its underside fixed with a hook 12 and its outer end provided with a handle 13. The main body 10 is disposed with a lock core 14 having a vertical engage pin 15 secured under the bottom and has the other end bored with an insert slot 16 for a telescopic rod 17 to be inserted therein. The telescopic rod 17 has one end fixed with a clasping member 18 and its surface disposed with plural sectional engage notches 19. In using, firstly, the steering wheel lock 1 is flatly placed on an automobile steering wheel and has the hook 12 under the resisting rod 11 hooked on the inner side of one end of the steering wheel. Next, the telescopic rod 17 is pulled outward to have the clasping member 18 clasped on the inner side of another end of the steering wheel. Thus, the resisting rod 11 is extended and positioned between the steering wheel and a driver's seat to restrict rotating angles of the steering wheel for preventing the automobile from being burglarized.

However, the conventional steering wheel lock 1 is likely to be destroyed by a burglar using tools to reversely knock the telescopic rod 17 or the main body 10 with a great force for breaking the engage pin 15 under the lock core 14, rendering the conventional steering wheel lock unable to produce locking effect.

### SUMMARY OF THE INVENTION

The objective of this invention is to offer an automobile steering wheel lock able to prevent a clasping member from slipping off a foundation base for really attaining effect of burglary prevention for automobiles.

The automobile steering wheel lock in the present invention includes a foundation base having its front end bored with an insert slot. The foundation base is formed with an accommodating chamber having its inner lower wall bored with an insert hole and a pin hole respectively communicating with the insert slot, and has its lower side disposed with a clasping holder and its rear side fixed with a resisting rod. A push-in lock to be positioned in the accommodating chamber of the foundation base is provided with a lock holder fitted therein with a lock core having its lower side disposed with a holding plate having its underside fixed with a vertical engage pin aligned to the insert hole in the inner lower wall of the accommodating chamber of the foundation base, with a spring fitted on the engage pin and positioned beneath the holding plate. A clasping member to be assembled at the front side of the foundation base has its lower end formed with a retaining member and its upper end provided with a positioning insert rod bored with at least one pin hole and having one side cut with a lengthwise slide recess. A fixing pin is to be inserted in both the pin hole in the inner lower wall of the accommodating chamber of the foundation base and the slide recess of the positioning insert rod of the clasping member.

### BRIEF DESCRIPTION OF DRAWINGS

This invention will be better understood by referring to the accompanying drawings, wherein:

FIG. 1 is an exploded perspective view of a conventional steering wheel lock;

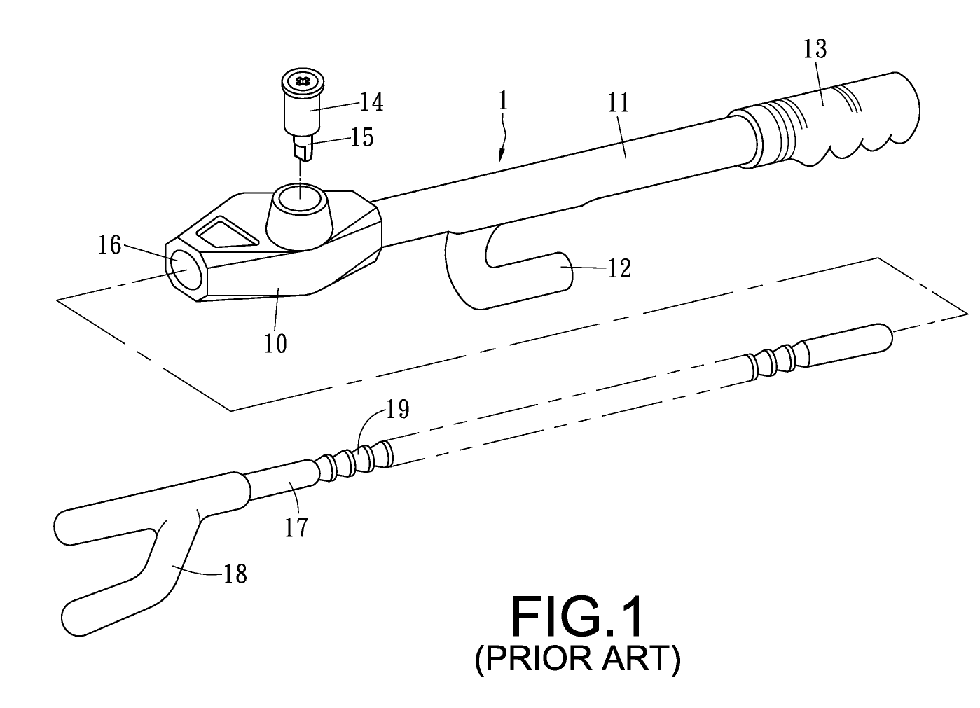

FIG. 2 is an exploded perspective view of an automobile steering wheel lock in the present invention;

FIG. 3 is a perspective view of the automobile steering wheel lock in the present invention;

FIG. 4 is a cross-sectional view of the automobile steering wheel lock in the present invention;

FIG. 5 is an upper view of the automobile steering wheel lock in the present invention;

FIG. 6 is a cross-sectional view of the automobile steering wheel lock in an unlocked condition in the present invention;

FIG. 7 is an upper view of the automobile steering wheel lock in an unlocked condition in the present invention; and

FIG. 8 is a perspective view of the automobile steering wheel lock locked on an automobile steering wheel in the present invention.

### DETAILED DESCRIPTION OF THE PREFERRED EMBODIMENT

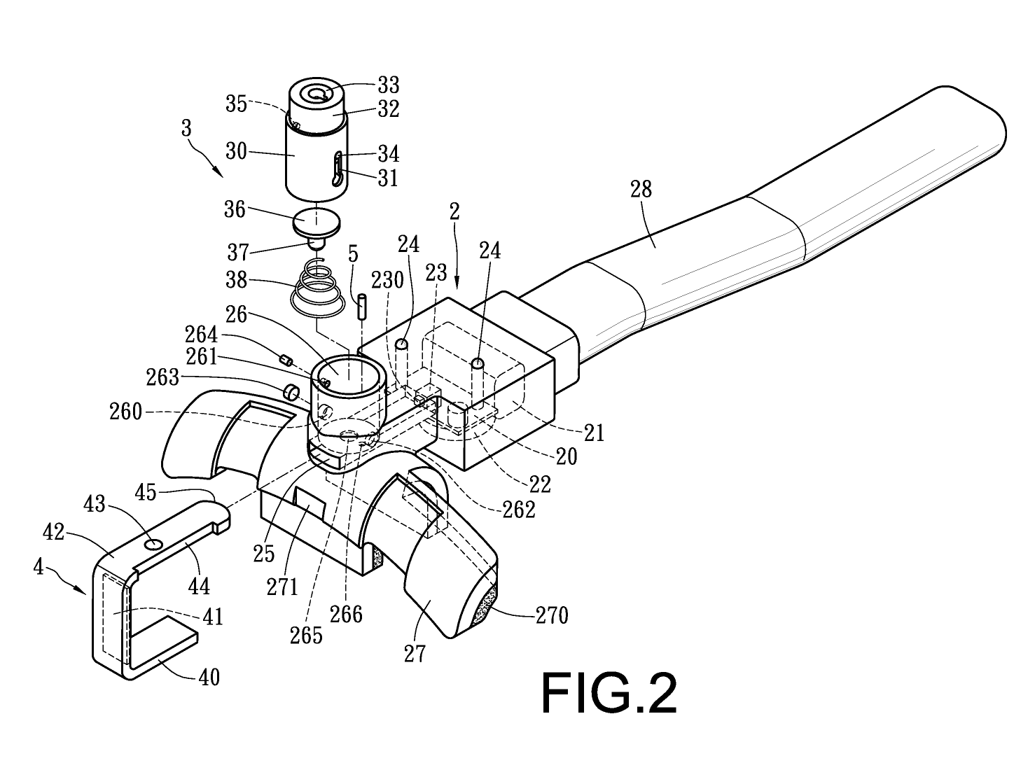

A preferred embodiment of an automobile steering wheel lock in the present invention, as shown in FIG. 2, includes a foundation base 2, a push-in lock 3, a clasping member 4 and a fixing pin 5 as main components combined together.

The foundation base 2 is installed with a circuit board 20, a battery 21 and a beeper 22 in the interior. The circuit board 20 is disposed thereon with a micro-switch 23 and a warning lamp 24 extended out of the topside of the foundation base 2. The foundation base 2 has its front end bored with a lengthwise insert slot 25, and the micro-switch 23 is provided with a press-trigger member 230 extending in the insert slot 25. Further, the foundation base 2 is formed with an accommodating chamber 26 having its circumferential wall bored with an insert hole 260, a pin hole 261 and a positioning recess 262 at a corresponding side of the insert hole 260, with a stopper 263 clogged in the insert hole 260 and a fixing pin 264 inserted in the pin hole 261. The accommodating chamber 26 has its inner lower wall bored with an insert hole 265 and a pin hole 266 respectively communicating with the insert slot 25 of the foundation base 2. Furthermore, the foundation base 2 has its lower side fixed with a clasping holder 27 provided inside with a protective pad 270 and having its front side bored with a recess 271, having its rear side secured with a resisting rod 28.

The push-in lock 3 to be received in the accommodating chamber 26 of the foundation base 2 is provided with a lock holder 30 having its outer wall cut with a lengthwise slot 31, and a lock core 32 is fitted in the interior of the lock holder 30, having a rotary member 33 assembled therein and having its outer wall fixed with an engage stud 34 inserted out of the lengthwise slot 31 of the lock holder 30. The lock holder 30 further has its outer wall bored with a positioning pin hole 35. A holding plate 36 is disposed under the lock core 32 and has its underside fixed with a vertical engage pin 37 fitted thereon with a spring 38 positioned beneath the holding plate 36, and the engage pin 37 and the spring 38 are together received in the interior of the lock holder 30.

The clasping member 4 to be assembled at the front side of the foundation base 2 has its lower end bent inward to form a retaining member 40 and its upper end bent inward to form a positioning insert rod 42 and further has its inner wall provided with a protective pad 41. The positioning insert rod 42 is bored with a pin hole 43, having one side cut with a lengthwise slide recess 44 and its inner end formed with a press end 45.

The fixing pin 5 is to be inserted through the pin hole 266 in the inner lower wall of the accommodating chamber 26 of the foundation base 2 and fixed in the slide recess 44 of the positioning insert rod 42.

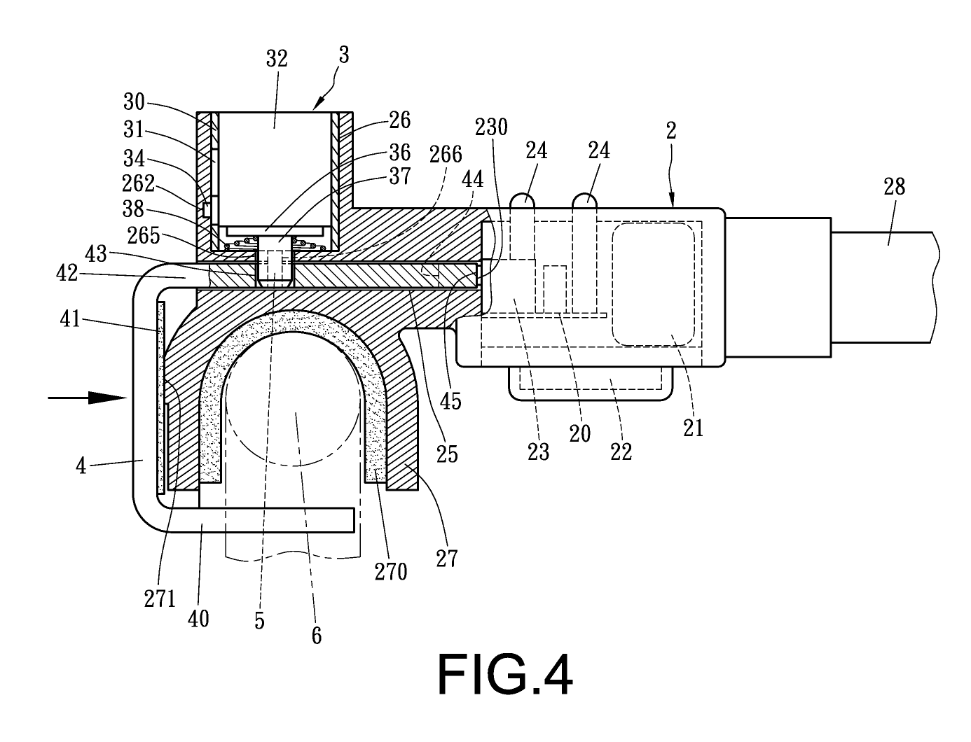

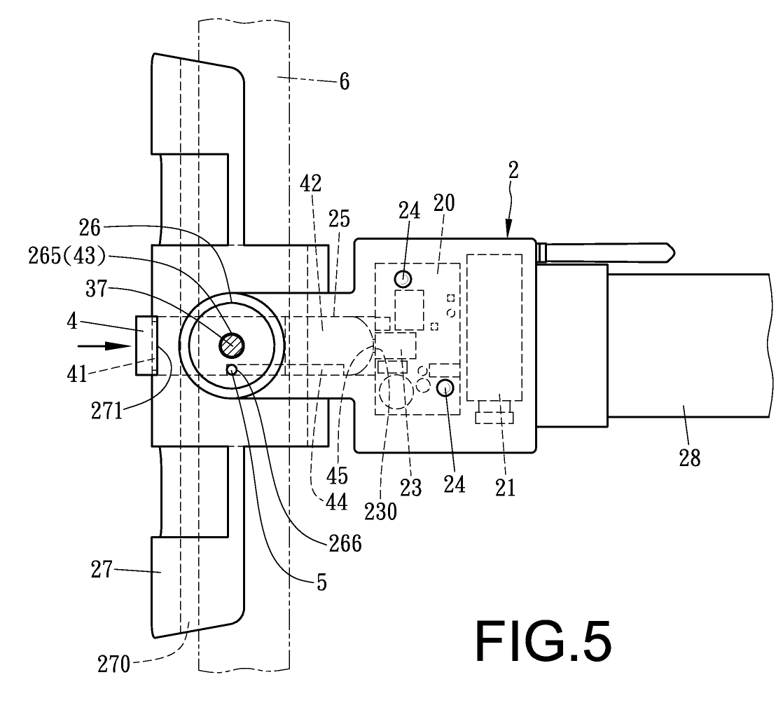

In assembling, as shown in FIGS. 2 to 5, firstly, the positioning insert rod 42 of the clasping member 4 is inserted in the insert slot 25 of the foundation base 2, and the fixing pin 5 is inserted through the pin hole 266 in the inner lower wall of the accommodating chamber 26 of the foundation base 2 and has its lower end fixing the slide recess 44 of the positioning insert rod 42 in the insert slot 25 so as to stop the clasping member 4 from disengaged from the foundation base 2. Next, the push-in lock 3 is received in the accommodating chamber 26 of the foundation base 2, and the spring 38 and the engage pin 37 of the push-in lock 3 are positioned in the lock holder 30, letting the spring 38 fitted around the engage pin 37 and have its upper end pushing against the holding plate 36 on the engage pin 37 and also letting the topside of the holding plate 36 closely contact with the underside of the lock core 32. Subsequently, the positioning pin hole 35 of the lock holder 30 is aligned to the pin hole 261 in the circumferential wall of the accommodating chamber 26 of the foundation base 2 and then the fixing pin 264 is inserted in both the pin hole 261 of the foundation base 2 and the positioning pin hole 35 of the lock holder 30 to fix the lock holder 30 in the accommodating chamber 26 of the foundation base 2. Afterward, the stopper 263 is clogged in the insert hole 260 and the lock core 32 is press inward to let the engage stud 34 on the outer wall of the lock core 32 engaged in the positioning recess 262 in the accommodating chamber 26 to firmly position the lock core 32 inside the lock holder 30. Thus, when pressed down, the lock core 32 will press the holding plate 36 together with the engage pin 37 to move downward, and synchronously the holding plate 36 will press the spring 38 to let the spring 38 kept in an elastically compressed state and the engage pin 37 will have its lower end inserted in the pin hole 43 of the positioning insert rod 42 of the clasping member 4 to lock the clasping member 4 in position, thus finishing assembly of the steering wheel lock.

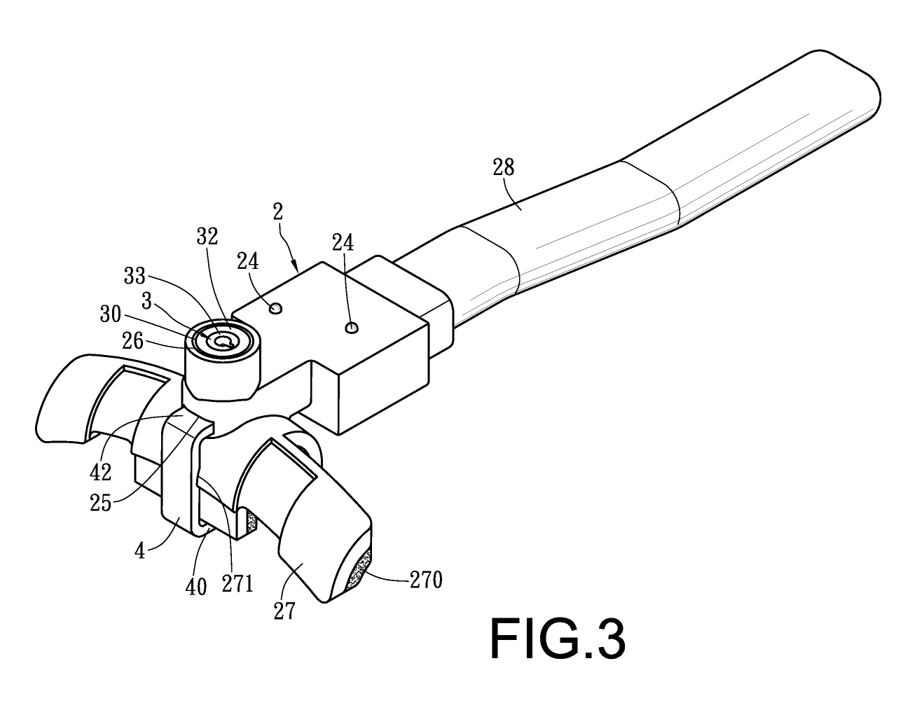

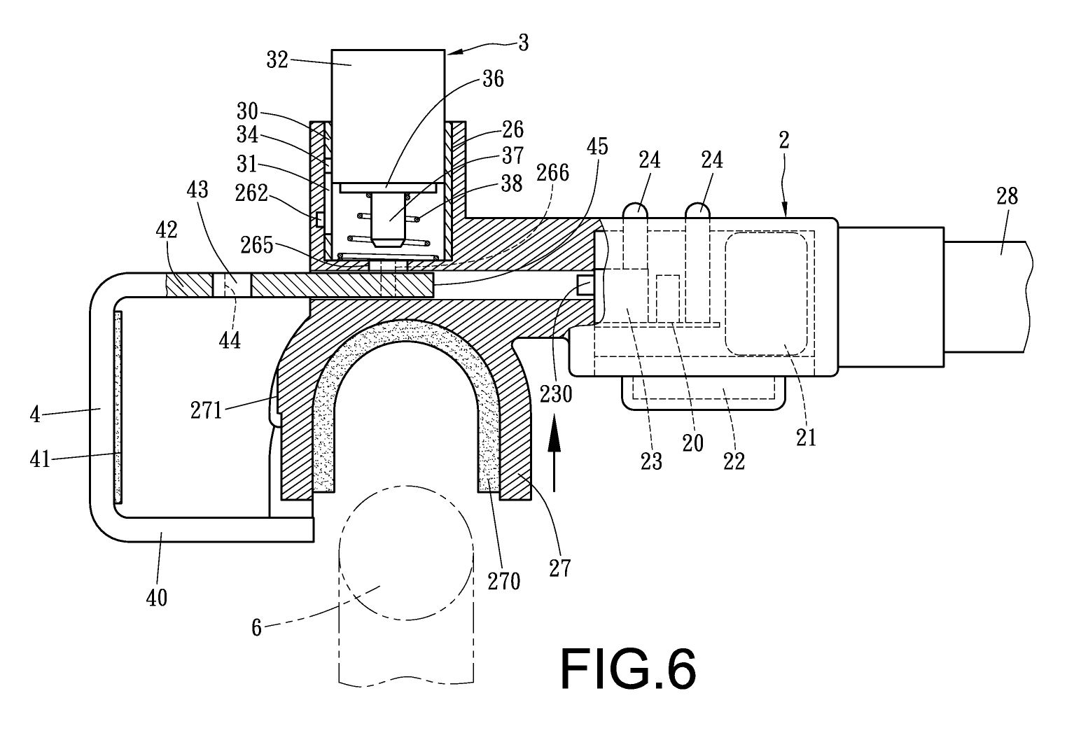

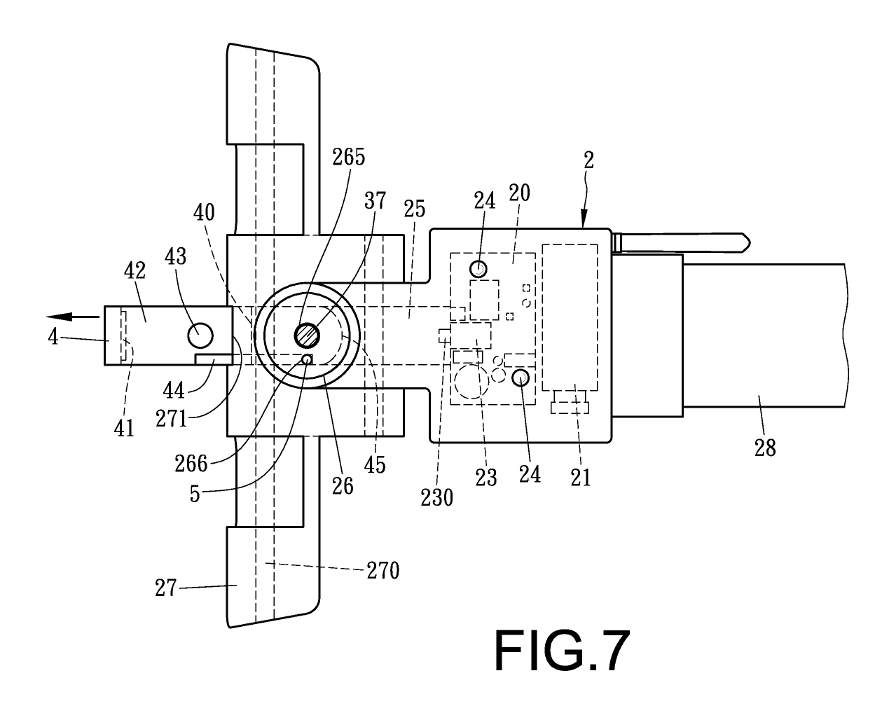

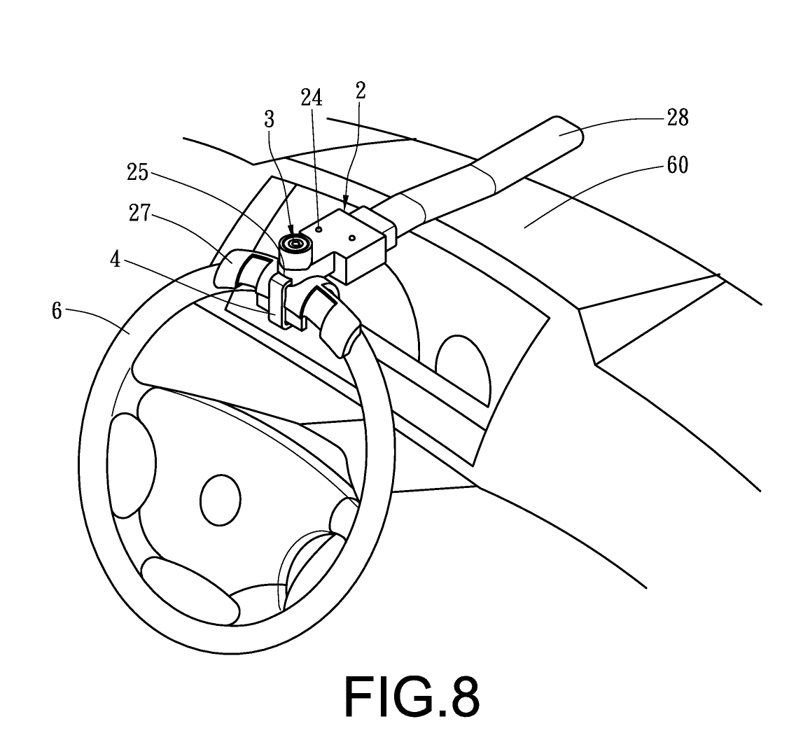

To lock the steering wheel lock on an automobile steering wheel 6, referring to FIGS. 3 to 8, firstly, the clasping holder 27 of the steering wheel lock is positioned astride the steering wheel 6 and the resisting rod 28 is resisted on the automobile instrument panel 60. Next, the clasping member 4 is moved inward to have its positioning insert rod 42 inserted in the insert slot 25 of the foundation base 2, letting the pin hole 43 of the clasping member 4 aligned to the insert hole 265 in the inner lower wall of the accommodating chamber 26 of the foundation base 2, and at this time, the retaining member 40 at the lower end of the clasping member 4 is moved inward to block the underside of the clasping holder 27, letting the steering wheel 6 clasped and restrictedly positioned inside the clasping holder 27 and the clasping member 4 closely rest against the recess 271 at the front side of the clasping holder 27. The protective pad 41 on the inner wall of the clasping member 4 is able to prevent the clasping member 4 from bumping against the clasping holder 27 and producing noises or causing damage, and the protective pad 270 on the inner wall of the clasping holder 27 can function to protect the steering wheel 6 from being scraped and damaged. Then, the lock core 32 of the push-in lock 3 is pressed down to actuate the holding plate 36 and the engage pin 37 beneath the lock core 32 to move downward. Simultaneously, the holding plate 36 on the engage pin 37 will be pressed on the spring 38 to let the spring 38 kept in an elastically compressed state, and the engage pin 37 will be moved downward and inserted in both the insert hole 265 in the inner lower wall of the accommodating chamber 26 of the foundation base 2 and the pin hole 43 of the positioning insert rod 42 in the insert slot 25 to firmly position the positioning insert rod 42 in the insert slot 25 of the foundation base 2, letting the positioning insert rod 42 impossible to be moved outward. Meanwhile, the engage stud 34 on the outer wall of the lock core 32 will be moved downward and engaged in the positioning recess 262 in the inner circumferential wall of the accommodating chamber 26 to fix the lock core 32 in the lock holder 30. When the positioning insert rod 42 of the clasping member 4 is pushed inward to move into the insert slot 25 of the foundation base 2, the press end 45 of the positioning insert rod 42 will press and touch the press-trigger member 230 of the micro-switch 23 to turn on the warning lamp 24 and start the alarm system of the steering wheel lock, thus finishing locking work.

To unlock the steering wheel lock, simply turn around the lock core 32 with a key to let the engage stud 34 on the outer wall of the lock core 32 contracted inward and disengaged from the positioning recess 262 in the inner circumferential wall of the accommodating chamber 26 of the foundation base 2. At this time, the spring 38 will recover its elastic force to push upward the holding plate 36 and the lock core 32, and synchronously the engage pin 37 will be moved upward together with the holding plate 36 to have its lower end disengaged from the pin hole 43 of the positioning insert rod 42 and no longer restricting the positioning insert rod 42 in position, and thus the clasping member 4 can be pulled outward. After the positioning insert rod 42 is moved outward, the press end 45 of the positioning insert rod 42 will no longer press the press-trigger member 230 of the micro-switch 23, and hence the warning lamp 24 will be turned out and the alarm system will be out. Then, remove out the clasping member 4 to let its retaining member 40 moved away from the lower side of the clasping holder 27 and no longer block the steering wheel 6, and thus the steering wheel lock can be removed from the steering wheel 6 to finish unlocking work.

Specifically, the positioning insert rod 42 of the clasping member 4 has one side provided with the slide recess 44, and the fixing pin 5 provided in the insert slot 25 of the foundation base 2 is inserted in the slide recess 44 for firmly positioning the positioning insert rod 42 of the clasping member 4 in the insert slot 25 of the foundation base 2 for preventing the clasping member 4 from slipping off the foundation base 2, able to carry out locking and unlocking work quickly and conveniently and really achieve effect of preventing the automobile from being burgled.

While the preferred embodiment of the invention has been described above, it will be recognized and understood that various modifications may be made therein and the appended claims are intended to cover all such modifications that may fall within the spirit and scope of the invention.

What is claimed is:

1. An automobile steering wheel lock comprising:
a foundation base having its front end bored with an insert slot, said foundation base provided with an accommodating chamber having its inner wall bored with an insert hole and a pin hole, said insert hole and said pin hole communicating with said insert slot, said foundation base having its lower side disposed with a clasping holder and its rear side secured with a resisting rod;
a push-in lock received in said accommodating chamber of said foundation base, said push-in lock provided with a lock holder having a lock core installed in its interior, a holding plate assembled under said lock core, said holding plate having its underside fixed with an engage pin aligned to said insert hole in an inner wall of said accommodating chamber of said foundation base, a spring fitted on said engage pin and positioned beneath said holding plate;
a clasping member assembled at a front side of said foundation base, said clasping member having its lower end provided with a retaining member and its upper end provided with a positioning insert rod, said positioning insert rod bored with at least one pin hole for said engage pin to be inserted therein, said positioning insert rod having one side provided with a slide recess; and
a fixing pin inserted in both said pin hole in an inner wall of said accommodating chamber of said foundation base and said slide recess of said positioning insert rod.

2. The automobile steering wheel lock as claimed in claim 1, wherein said foundation base is disposed with a circuit board, a battery and a beeper in its interior, said circuit board assembled thereon with a micro-switch and at least one warning lamp, said warning lamp extended out of a topside of said foundation base, said micro-switch provided with a press-trigger member extending in said insert slot, said positioning insert rod of said clasping member having one end provided with a press end.

3. The automobile steering wheel lock as claimed in claim 1, wherein said accommodating chamber of said foundation base has its circumferential wall bored with a pin hole, and said lock holder has its outer wall bored with a positioning pin hole, a fixing pin inserted in both said pin hole of said foundation base and said positioning pin hole of said lock holder to fix said lock holder in said accommodating chamber of said foundation base.

4. The automobile steering wheel lock as claimed in claim 1, wherein said accommodating chamber of said foundation base has its circumferential wall bored with a positioning recess, said lock holder of said push-in lock provided with a slot, said lock core having a rotary member installed in its interior and having its outer wall fixed with an engage stud, said engage stud inserted through said slot of said lock holder to be engaged in said positioning recess of said foundation base.

5. The automobile steering wheel lock as claimed in claim 1, wherein said clasping member has its inner wall disposed with a protective pad.
